(19) United States
(12) Patent Application Publication
(10) Pub. No.: US 2007/0023740 A1
(43) Pub. Date: Feb. 1, 2007

(54) Use of fluorinated esters in fire extinguishing compositions

(75) Inventor: Jeffrey D. Michael, Marinette, WI (US)

Correspondence Address: Dean D. Small;THE SMALL PATENT LAW GROUP LLP, SUITE 1611, 611 OLIVE STREET, SAINT LOUIS, MO, 63101, US

(73) Assignee: ANSUL, INC.

(21) Appl. No.: 11/493,343

(22) Filed: Jul. 26, 2006

Related U.S. Application Data
(60) Provisional application No. 60/703,741, filed on Jul. 29, 2005.

(51) Int. Cl. C09K 21/00

(52) U.S. Cl. 252/601

(57) ABSTRACT

Compositions and methods for fluorinated ester utilization as clean fire extinguishing agents are disclosed.

### RELATED APPLICATION

The present application relates to and claims priority from Provisional Application Ser. No. 60/703,741 filed Jul. 29, 2005 titled “CLEAN FIRE SUPPRESSION AGENTS”, the complete subject matter of which is hereby expressly incorporated in its entirety.

### BACKGROUND OF THE PRIOR ART

This invention relates to fire extinguishing compositions comprising fluorinated compounds, and to methods for extinguishing, controlling, or preventing fires by using such compositions effectively while leaving no residue (thus functioning as clean extinguishing agents). It particularly relates to new and improved fluorinated ester clean agents.

In the past, clean agents have been used in a variety of applications for extinguishing fires. They have been used in flooding applications as, for example, to protect fixed enclosures such as computer rooms, document storage vaults, libraries, and areas for artwork, and other areas where water threatens to cause undue damage to the contents or create particularly hazardous conditions, such as petroleum pipeline pumping stations and the like. Clean agents have also been employed as liquid streamers or injected as gas or vapor into enclosed spaces such as machine housings and utility closets. Streaming operations often require rapid extinguishing such as with commercial handheld extinguishers or fixed system local applications. Clean agents, unlike water, serve to extinguish or suppress the fires while causing little, if any, damage to the enclosure or the contents. Various methods of using clean fire suppression agents in both total flooding and in portable streaming applications are illustrated in U.S. Pat. No. 6,849,194. The most commonly used clean agents were for many years halogenated hydrocarbons such as bromotrifluoromethane (Halon™ 1301) and bromochlorodifluoromethane (Halon™ 1211). Although being highly effective, these compounds have been linked to ozone depletion in recent years, therefore creating a demand for replacement clean agents. Various fluorocarbons and hydrofluorocarbons have been offered as substitutes but have had their own residual environmental disadvantages because of their extended lifetime in the atmosphere and because of their contributions to global warming.

U.S. Pat. Nos. 6,478,979 and 6,630,075 by Behr, et al. have disclosed fluorinated ketone compounds which have a shorter atmospheric lifetime than many other halogenated clean agents such as Halon™ 1301 and 1211 by virtue of being photo hydrolyzable. That is, under the effect of atmospheric UV radiation fluorinated ketones have been shown to break down in “approximately 1-2 weeks”.

(Taniguchi et al, Journal of Physical Chemistry A, 107(15), 2674-2679, 2003.) The end product of this degradation—CO₂ and presumably HF has been used to calculate a potential Global Warming Potential (GWP) for these agents.

Compounds such as fluorinated ketones do have some problems dissipating or hydrolyzing into the atmosphere. Their manufacture also requires treating with an alkyl permanganate in a suitable organic solvent in order to remove inherent dimer and trimer by-products.

Clean agents that would atmospherically hydrolyze into water soluble fragments without generating CO₂ or HF would be desirable, fulfill a need in the industry, and if, in addition, they have other advantages of low toxicity, non-flammability, low boiling point, and good storage stability, such clean agents would be a welcomed advancement in the art.

### SUMMARY OF THE INVENTION

Although perfluorinated esters are generally known to be very unstable (i.e. not tolerating even one fluorine attached to the alcohol/oxygen carbon), and weak nucleophiles such as fluorine or methanol molecules will serve as catalyst for rapidly degrading fluorinated esters, and even though esters having only one hydrogen or carbon attached to the alcohol/oxygen carbon are more stable, it has been found that relatively small amounts of hydrogen greatly increase the flammability of these compounds. For example, 2,2,2-trifluoroethyl trifluoro acetate has only 2 hydrogen atoms and has a flashpoint of only 0° centigrade. However, we have discovered that there are particular perfluorinated esters which are non-flammable and fulfill all or most of the desirable characteristics for clean agents. These particular esters are volatile, capable of fire suppression by both air exclusion and by cooling, and are highly inert to oxidation, stable in storage, and yet rapidly hydrolyze in the atmosphere to form water soluble fragments. Additionally, this particular group of esters covers a broad range of different boiling points, i.e., 30° C. to 100° C., so as to enable specific applications as either flooding agents or streaming agents. The particular fluoro esters of the present invention are novel fire retarding esters having the formula
R¹COOCR²(CF₃)₂

wherein R¹=H, CF₃, C₂F₅, C₃F₇, or CF₃CO, and

R²=H or CF₃.

### DETAILED DESCRIPTION AND PREFERRED EMBODIMENTS

Compounds utilized in the processes and compositions of the invention are perfluorinated ester compounds. The perfluorinated esters of this invention can be utilized alone, in combination with one another, or in combination with other known extinguishing agents (e.g., fluorinated ketones, hydro-fluorocarbons, hydro-chlorofluorocarbons, perfluorocarbons, perfluoroethers, hydro-fluoropolyethers, hydro-fluoroethers, chlorofluoroethers, bromo-fluorocarbons, bromo-chlorofluorocarbons, hydro-bromocarbons, iodofluorocarbons, and hydrobromofluorocarbons). This allows one to adjust the properties of the mixture to correlate maximum performance for a specific application. For example, esters are higher boiling relative to many common clean agents, and when combined with one of the lower boiling agents, esters seem to increase the “throw distance” for the mixtures. When combining esters with ketones which are also higher boiling clean agents, the boiling point can be correlated to within a fraction of a degree. The compounds can be liquid or gaseous under ambient conditions of temperature and pressure, thus are preferably utilized for extinguishing fires in the liquid or the vapor state.

Perfluorinated esters provide efficient fire suppression properties while offering oxygen functionality, which is essential to more rapidly hydrolyzing the compounds into water soluble fragments, which are more easily cleared from the atmosphere than are, for example, the photo hydrolyzed by products of using perfluorinated ketones. Accordingly, the perfluorinated esters result in no ozone destruction and lower atmospheric global warming than either fluorinated ethers or fluorinated ketones, including those sold under the brand name Novec 1230, and including those disclosed in U.S. Pat. Nos. 6,478,979 and 6,330,075.

Representative of the perfluorinated esters of the present invention are compounds prepared by joining, for example, perfluorotertiary-butyl alcohol or hexafluoroisopropyl alcohol with one of the following five carboxylic acids: formic acid, trifluoroacetic acid, pentafluoropropionic acid, heptafluorobutyric acid, or trifluoropyruvic acid. More particularly, the perfluorinated esters which are reaction products of the above may be represented by the general formula as follows:
R¹COOCR²(CF₃)₂

wherein R¹=H, CF₃, C₂F₅, C₃F₇, or CF₃CO, and

R²=H or CF₃.

Methods for synthesizing esters of the present invention are well known to those in the art. The esters may be purified by distillation to enable long-term stable storage, even where they can remain stable under elevated temperatures. Yet, the esters may be readily hydrolyzed under atmospheric moisture conditions (upon discharge). The high fluorine and low hydrogen content of the esters contribute to their efficacy as fire suppression agents. The compounds have low molecular weight and evaporate relatively quickly thereby leaving the area of discharge “clean”. Perfluorinated esters are structurally different from any of the prior art fire suppression agents. Although fluorine containing esters generally have been reported in the chemical literature, only three of the previously reported esters are structurally similar to compounds of the present invention and those compounds are hexafluoroisopropyl trifluoroacetate, CAS registration number [42031-15-2], perfluoro t-butyl trifluoroacetate [24165-10-4] and hexafluoroisopropyl pentafluoropropionate [115720-33-7]. None of these three compounds, however, were suggested even remotely for use in fire suppression. This is because even a small amount of hydrogen in the compounds render them flammable as seen from the flash points listed for various hydro-fluoro-chemicals and as determined in our laboratory using the Pensky-Martens closed cup method. On the other hand, when the hydrogen is replaced with fluorine to render a compound less flammable, they become structurally unstable as noted by Shreeve, J. Organic Chemistry, 38, 4028 (1973). That is, esters of the general structural type shown above but with R²═F are reported to decompose rapidly when traces of fluorine ions or moisture are present. Accordingly, it would not have been readily apparent that the esters of the present invention would combine non-flammability, low boiling point, and good storage stability.

Characteristic of the compounds of the present invention are their boiling points ranging from 30° C. to 100° C. The lower boiling esters are more suitable for total flooding applications where a pre-measured quantity of the compound is rapidly vaporized into a room or other enclosed space when utilized for fire suppression. Higher boiling esters are better served at streaming applications in, for example, hand operated portable fire extinguishers or other such applications where throw distance is an important factor.

Generally perfluorinated esters like other fluorocarbon agents are known to generate some acidic hydrogen fluoride from thermal decomposition during the course of their application as fire suppressants. This residual effect can be potentially damaging and highly toxic. The effect, however, can be mitigated by the addition of small amounts of a neutralizing agent such as, for example, perfluoroamines including, for example, perfluorotrimethylamine or perfluorotriethylamine. Also compositions of the present invention may be supplemented with wetting agents including, for example, fluorinated alcohols or fluorine containing surfactants such as perfluorobutyl carbitol [152914-73-3] or DuPont's Zonyl FSN [101027-76-3] in order to counteract the hydrophobic and/or lipophobic characteristics of fluorinated compounds.

Specifically the compounds of the present invention may be identified by the following names and formulas:
1,1,1,3,3,3-hexafluoro-2-propyl formate HCOOCH(CF₃)₂
1,1,1,3,3,3-hexafluoro-2-propyl trifluoroacetate CF₃COOCH(CF₃)₂ CAS [4231-15-2]
1,1,1,3,3,3-hexafluoro-2-propyl pentafluoropropionate CF₃CF₂COOCH(CF₃)₂ CAS [115720-33-7]
1,1,1,3,3,3-hexafluoro-2-propyl heptafluorobutyrate CF3CF2CF2COOCH(CF₃)₂
1,1,1,3,3,3-hexafluoro-2-propyl trifluoropyruvate CF₃COCOOCH(CF₃)₂
Perfluoro t-butyl formate HCOOC(CF₃)₃
Perfluoro t-butyl trifluoroacetate CF₃COOC(CF₃)₃ CAS [24165-10-4]
Perfluoro t-butyl pentafluoropropionate CF₃CF₂COOC(CF₃)₃
Perfluoro t-butyl heptafluorobutyrate CF_{3 CF}₂CF₂COOC(CF₃)₃
Perfluoro t-butyl trifluoropyruvate CF_{3 COCOOC(CF}₃)₃

As previously stated, the esters of the present invention may be prepared using the customary esterification methods known to those skilled in the art of synthetic chemistry, starting from the two alcohols previously mentioned and the five carboxylic acids or in the alternative, the anhydrides corresponding to the acids, or even mixed anhydrides, acid halides or triflates may be employed. Literature references to the manufacture of esters are cited below.
Pavlik and Toren, J. Organic Chemistry, 35, 2054 (1970)
Schreeve and Majid, J. Organic Chemistry, 38, 4028 (1973)
Pasquale, J. Organic Chemistry, 38, 3025 (1973)
Pasquale, U.S. Pat. No. 3,445,507
Bjornson, U.S. Pat. No. 4,026,930
Knunyants, Postovoi, Delyagina, and Zeifman, Izvestiya Akademii Nauk SSSR, 10, 2256 (1987)
Walker and DesMarteau, J. Fluorine Chemistry, 5, 135 (1975)
Johnson and Tittle, J. Fluorine Chemistry, 3, 1 (1973/74)
Forbus, Taylor, and Martin, J. Organic Chemistry, 52, 4156 (1987)

The extinguishing process of the present invention can be carried out by introducing a non-flammable extinguishing composition comprising at least one fluorinated ester compound to a fire or flame. The fluorinated esters can be utilized alone or in a mixture with each other or with other commonly used clean extinguishing agents, for example, CHF₃ (FE-13), CHF₂CF₃ (FE-25), CF₃CHFCF₃ (FM-200), and CF₃CH₂CF₃ (FE-36) etc. Such co-extinguishing agents may be chosen to enhance the extinguishing capabilities or modify the physical properties (for example, modify the rate of introduction by serving as a propellant) of an extinguishing composition for a particular type (or size or location) of fire and can preferably be utilized in ratios (of co-extinguishing agent to fluorinated ester compounds) such that the resulting composition does not form flammable mixtures in air. Preferably, the extinguishing mixture contains from about 10 to 90% by weight of at least one fluorinated ester and from about 90 to 10% by weight of at least one co-extinguishing agent. Preferably, the fluorinated ester compounds used in the composition have boiling points in the range of 30° C. to 100° C.

The extinguishing composition can preferably be used in either the gaseous or the liquid state (or both), and any of the known techniques for introducing the composition to a fire can be utilized. For example, a composition can be introduced by streaming, by misting, or by flooding the composition into an enclosed space surrounding a fire or hazard. The composition can optionally be combined with inert propellants, including, for example, nitrogen, argon, or carbon dioxide, to increase the rate of discharge of the composition from the streaming or flooding equipment utilized.

Preferably, the extinguishing compositions introduced into a fire or flame in an amount sufficient to extinguish the fire or flame. One skilled in the art will recognize that the amount of extinguishing composition needed to extinguish a particular hazard will depend upon the nature and extent of the hazard. When the extinguishing composition is to be introduced by flooding, cup burner test data (for example, the type described in the Examples, infra.) can be used in determining the amount or concentration of extinguishing composition required to extinguish a particular type and size of fire.

The ratio of co-extinguishing agent to fluorinated ester is preferably such that the resulting composition provides the optimum agent dispersion and “throw distance” for a particular fire fighting situation and delivery device. The weight ratio of co-extinguishing agent to fluorinated ester may vary from about 9:1 to about 1:9. These fluorinated ester compositions can be utilized in co-application processes with different fighting technologies to provide enhanced extinguishing capabilities.

Another co-application process for utilizing fluorinated esters is that of extinguishing a fire using a combination of a gelled halocarbon with a dry chemical. A dry chemical can be introduced in suspension in the ester and discharged from an manual hand held extinguisher or from a fixed system.

Still another co-application process utilizing fluorinated esters is a process where the fluorinated ester is super pressurized upon activation of a manual hand held extinguisher or fixed system using an inert gas generated by the rapid decomposition of an energetic material such as glycidyl azide polymer. In addition, rapid decomposition of the energetic material such as glycidyl azide polymer yields a hot gas (for example, rapid decomposition of an energetic material) which might be used to propel liquid fluorinated esters of the invention to facilitate dispersal.

Compositions of the present invention may be introduced and maintained in an amount sufficient to impart to the air, in an enclosed area, a heat capacity per mole of total oxygen present that will suppress combustion of combustible materials in the enclosed area. The minimum heat capacity required to suppress combustion varies with the combustibility of the particular flammable materials present in the enclosed area. Combustibility varies according to chemical composition and according to physical properties such as surface area relative to volume, porosity, etc.

In general, a minimum heat capacity of about 45 calories per degree centigrade per mole of oxygen is adequate to extinguish or protect moderately combustible materials such as wood or plastic, and a minimum of about 50 calories per degree centigrade per mole of oxygen is adequate to extinguish or protect highly combustible materials, for example, paper, cloth, and certain volatile flammable liquids. Greater heat capacities can be imparted if desired but may not provide significantly greater fire suppression for the additional cost involved. Methods for calculating heat capacity per mole of total oxygen present are well known from, for example, the calculations described in U.S. Pat. No. 5,040,609 by Dougherty, et al. The descriptions within that patent are herewith incorporated by reference.

The fire prevention process of the invention can be used to eliminate the combustion-sustaining properties of air and to thereby suppress the combustion of flammable materials. The process can be used continuously if a threat of fire always exists or can be used as an emergency measure if a threat of fire or deflagration develops.

The principal advantage of the fluorinated esters of the present invention as compared to other perfluorinated clean agents such as fluorocarbons, hydrofluorocarbons, fluoroethers and fluorinated ketones lie in the capability of the esters to be readily hydrolyzed by atmospheric moisture. The resulting alcohol and carboxylic acids are readily soluble in atmospheric moisture and therefore remain locked in the lower atmosphere and removed by precipitation. In contrast, fluorinated ketones are said to be broken down into CO₂ and HF which are undesirable atmospheric components.

Other objects and advantages of this invention are also further illustrated by the following Examples, but the particular materials and amounts thereof recited in these Examples, as well as other conditions and details, should not be construed to unduly limit this invention. Unless otherwise specified, all percentages and proportions are by weight.

### EXAMPLE 1

Preparation of Fluoroesters

A convenient method of preparing the fluoroesters described in this patent involves reaction of an acid halide, most preferably the acid chloride, with the alcohol in a suitable acid scavenger such as pyridine, 2-picoline, or triethylamine. In some cases the acid anhydrides may be employed under the same reaction conditions in place of the acid halide and may be more conveniently handled due to their higher boiling points. The preparation of 1,1,1,3,3,3-hexafluoro-2-propyl pentafluoropropionate is given below by way of illustrating the general method.

Pentafluoropropionyl Chloride (b.p.—4° C.)

205 g (1.25 moles) of pentafluoropropionic acid b.p. 97° C. is charged to a 500 ml stirred reaction vessel under N₂ together with 155 g (1.30 moles) of thionyl chloride. The vessel is fitted with a thermometer, dropping funnel and reflux condenser the top of which is connected by tubing to a dry ice-acetone trap. The mixture is cooled in an ice bath to +5° C. and 18 g (0.25 mole) of DMF is added dropwise at a rate to keep the temperature between +15-20° C. After stirring for 30 minutes the reaction is warned slowly to 55° C. At around 35° C. a steady off gas of HCl, SO₂, and propionyl chloride commences, and this proceeds steadily as the temperature rises until the reaction vessel is nearly empty. A small residue of DMF remains behind. At this point around 300 ml of clear liquid (SO₂ and propionyl chloride) has collected in the dry ice trap.

Esterification Reaction

A second reaction vessel is charged with 202 g (1.20 moles) of 1,1,1,3,3,3-hexafluoro-2-propanol and 238 g (2.55 moles) of 2-methylpyridine while cooling in an ice bath to control a small exotherm. The acid chloride-SO₂ mixture prepared above is allowed to vaporize by raising the collection trap above the level of the dry ice coolant. The vapor is conducted into the head space of the alcohol-pyridine reaction vessel which is maintained between +10 to 15° C. with the ice bath. When no more acid chloride vapor is seen to be entering the reaction vessel, the reaction is allowed to come to room temperature and stirred overnight. The reaction mixture is transferred to a separatory funnel where the dense fluoroesters layer is separated from the upper pyridine-pyridinium salts layer. 358 g of crude ester is obtained which is contaminated with excess 2-methylpyridine. The ester is easily purified by atmospheric distillation, giving 302 g (80% yield) of pure 1,1,1,3,3,3-hexafluoro-2-propyl pentafluoropropionate b.p. 62° C.

ir C═O 1817 cm⁻¹; MW 314; m/e 295(m-F), 275(m-HF₂), 195(m-CF₂CF₃), 151 (CF₃CHCF₃), 119(CF₂CF₃), 69(CF₃).

Similarly Prepared Were:

1,1,1,3,3,3-hexafluoro-2-propyl trifluoroacetate b.p. 48° C.

ir C═O 1830 cm⁻¹; MW 264; m/e 226(m-F₂), 225(m-HF₂), 195(m-CF₃), 151(CF₃CHCF₃), 113(CF₃CO₂), 97(CF₃CO), 69(CF₃).

1,1,1,3,3,3-hexafluoro-2-propyl heptafluorobutyrate b.p. 85° C.

ir C═O 1819 cm⁻¹; MW 364; m/e 345(m-F), 325(m-HF₂), 195(m-CF₂CF₂CF₃), 169(CF₂CF₂CF₃), 151 (CF₃ CHCF₃), 69(CF₃).

Perfluoro t-butyl trifluoroacetate b.p. 56° C.

ir C═O 1854 cm⁻¹; MW 332; m/e 313(m-F), 263(m-CF₃), 235(m-CF₃CO), 219(m-CF₃CO₂), 97(CF₃CO), 69(CF₃).

Extinguishment Concentrations for Clean
Agent Esters in Standard Cup Burner Test

| | | Extinguishment |
|---|---|---|
| | | Concentration |
| Agent | B.P. | For Heptane Fire |
| 1,1,1,3,3,3-hexafluoro- | 48° C. | 5.00% |
| 2-propyl trifluoroacetate | | |
| perfluoro t-butyl | 56° C. | 5.70% |
| trifluoroacetate | | |
| 1,1,1,3,3,3-hexafluoro-2- | 62° C. | 6.30% |
| propyl pentafluoropropionate | | |
| 1,1,1,3,3,3-hexafluoro-2- | 85° C. | 6.70% |
| propyl heptafluorobutyrate | | |

### EXAMPLE 2

Water Dissolution Rate of Hexafluoro-2-propyl Trifluoroacetate vs. Novec 1230

In separate, capped glass vials 10% suspensions of hexafluoro-2-propyl trifluoroacetate [42031-15-2] (B.P. 48° C.) or Novec 1230 [756-13-8] (B.P. 49° C.) were prepared in tap water. Each vial was stirred vigorously with a magnetic stirbar at ambient temperature (21-23° C.), and the dissolution of each agent observed periodically. In repeated trials the ester was observed to completely dissolve (hydrolyze) within 24-26 hours. In the same time period between 80-88% of the Novec 1230 was recovered unchanged.

The relatively rapid hydrolysis rate of fluoroesters by water is of considerable significance, because it increases the probability that these materials will be trapped in and cleared by moisture in the lower atmosphere. Less water soluble fluorocarbon materials have a much greater probability of reaching the upper (moisture free) atmosphere where their residence time will be prolonged.

While the invention has been described in terms of various specific embodiments, those skilled in the art will recognize that the invention can be practiced with modification within the spirit and scope of the claims.

What is claimed is:

1. A method of extinguishing a fire comprising applying to said fire at least one non-flammable composition comprising a perfluorinated ester compound containing 0, 1 or 2 hydrogen atoms bonded to carbon atoms in its carbon backbone and having a boiling point in the range of 30° C.-100° C., in an amount effective for extinguishing the fire.

2. The method of claim 1 wherein the perfluorinated ester is represented by the general formula R¹COOCR²(CF₃)₂
wherein R¹=H, CF₃, C₂F₅, C₃F₇, or CF₃CO, and
R²=H or CF₃.

3. The method of claim 1 wherein the perfluorinated ester has a boiling point of from about 40° C. to 90° C.

4. The method of claim 1 wherein the perfluorinated ester is 1,1,1,3,3,3-hexafluoro-2-propyl pentafluoropropionate.

5. A fire extinguishing composition comprising at least one perfluorinated ester containing 0, 1 or 2 hydrogen atoms bonded to the carbon atoms in the carbon backbone and selected from the group represented by the formula
R¹COOCR²(CF₃)₂
wherein R¹=H, CF₃, C₂F₅, C₃F₇, or CF₃CO, and
R²=H or CF₃.

6. The composition of claim 5 wherein the perfluorinated ester is combined with an effective amount of a neutralizing agent which is a perfluoroamine selected from the group consisting of perfluoro trimethylamine, perfluoro triethylamine.

7. The composition of claim 5 wherein the perfluorinated ester is combined with an effective amount of a second fire suppression agent selected from the group consisting of CHF₃, CHF₂CF₃, CF₃CHFCF₃, and CF₃CH₂CF₃, and perfluorinated ketones.

8. The composition of claim 5 wherein the at least one ester is wherein R¹=H.

9. The composition of claim 5 wherein the at least one ester is wherein R¹=CF₃.

10. The composition of claim 5 wherein the at least one ester is wherein R¹=C₂F₅.

11. The composition of claim 5 wherein the at least one ester is wherein R¹=C₃F₇.

12. The composition of claim 5 wherein the at least one ester is wherein R¹=CF₃CO.
